(19) United States
(12) Patent Application Publication
(10) Pub. No.: US 2009/0271024 A1
(43) Pub. Date: Oct. 29, 2009

(54) Cutting Apparatus

(76) Inventor: Paul Robert McCleary, Oyster Bay (AU)

Correspondence Address: JANSSON SHUPE & MUNGER LTD., 245 MAIN STREET, RACINE, WI, 53403, US

(21) Appl. No.: 12/225,215

(22) PCT Filed: Mar. 19, 2007
(86) PCT No.: PCT/AU2007/000336

§ 371 Date: Sep. 16, 2008

(30) Foreign Application Priority Data
Mar. 21, 2006 (AU) 2006901449

(51) Int. Cl. G05B 19/406; B23K 9/00; B23K 9/32

(52) U.S. Cl. 700/160; 219/121.39; 219/121.58; 219/121.54

(57) ABSTRACT

A cutting apparatus (1) includes a base (5) having upwardly extending first and second ends (10, 15) between which spaced elongate sides extend (20, 25). The ends and sides (10, 15, 20, 25) being located in a plane. The plane being inclined by an acute angle to a vertical plane. A cutting device (35) is provided to cut sheet material supported on the base (5). The device (1) is mounted on and moveable relative to the sides and ends (10, 15, 21, 25). Means (30) urges the cutting device (35) to desired locations relative to the base (5) thereby enabling the device (1) to cut the sheet material at desired locations.

### FIELD OF THE INVENTION

The present invention relates to a cutting apparatus, and in particular to, a vertical CNC cutting table.

### BACKGROUND OF THE INVENTION

In industrial applications sheet material such as steel is cut in large quantities and in varying shapes and sizes by industrial cutting apparatus. As sheet material is expensive, waste is common and complicated shapes are increasingly required, cutting apparatus have been developed which incorporate computers or the like to more efficiently control the cutting process. An example of such an apparatus is a Computer Numerical Control (CNC) cutting machine. Such machines control the movement of a cutting tool by numbers. By use of a programmable control unit the cutting tool can be moved using software to specific locations about a cutting table to cut complicated shapes at close tolerances. These types of machines typically include large horizontal tables upon which heavy sheet material is laid, the cutting tool proceeding above the table and sheet material. The cutting tool is typically controlled by a computer control unit to move the cutting tool in the X, Y and Z directions.

Existing apparatus however have the disadvantage that they are large in size covering a significant “footprint” of a factory floor, create occupational health and safety problems in that the operator must stretch over large sheets of material which are laid horizontally on the cutting table, it is difficult to retrieve components that may be centrally located on the table and it is difficult to enclose existing apparatus with safety barriers and the like. Further, existing apparatus can not be placed against a factory wall as access is required on all sides when using a horizontal cutting table. Also, spent gas used in existing apparatus is sucked from the bottom down which is not efficient as the gas, by way of its nature, wants to rise up above the horizontal table. The apparatus must also be strengthened as the entire weight of the sheet material bears fully on the table legs. Large drive motors are also required to move heavy sheet material about a horizontal cutting table.

### OBJECT OF THE INVENTION

It is an object of the present invention to overcome or ameliorate some of the disadvantages of the prior art, or at least to provide a useful alternative.

### SUMMARY OF THE INVENTION

There is firstly disclosed herein a cutting apparatus including:

a base having upwardly extending first and second ends between which spaced elongate sides extend, with the ends and sides being located in a plane; said plane being inclined by an acute angle to a vertical plane;

a cutting device to cut sheet material supported on the base, the device being mounted on and moveable relative to the sides and ends; and

means to urge said cutting device to desired locations relative to said base thereby enabling said device to cut the sheet material at said desired locations.

Preferably, said urging means includes a carriage to move said cutting device relative to said sides and ends, the carriage mounted on the base.

Preferably, said carriage includes a first assembly to move said cutting device between said ends and a second assembly to move said cutting device between said sides.

Preferably, said urging means includes a motor operatively associated with said carriage to change the location of said cutting device relative to said sides and ends.

Preferably, said cutting device includes at least one cutting torch.

Preferably, said cutting device includes means to change the orientation of said at least one torch relative to said base.

Preferably, including a housing substantially surrounding said apparatus.

Preferably, said apparatus includes electronic control means.

Preferably, said acute angle is less than about 45 degrees.

Preferably, said apparatus includes Computer Numerical Control.

Preferably, said apparatus includes a crane.

### BRIEF DESCRIPTION OF THE DRAWINGS

A preferred embodiment of the invention will now be described, by way of example only, with reference to the accompanying drawings, wherein:

FIG. 1 is a front view of an embodiment of the invention;

FIG. 2 is an end view of an embodiment of the invention;

FIG. 3 is a further end view of an embodiment of the invention; and

FIG. 4 is a further front view of an embodiment of the invention.

### DETAILED DESCRIPTION OF THE PREFERRED EMBODIMENTS

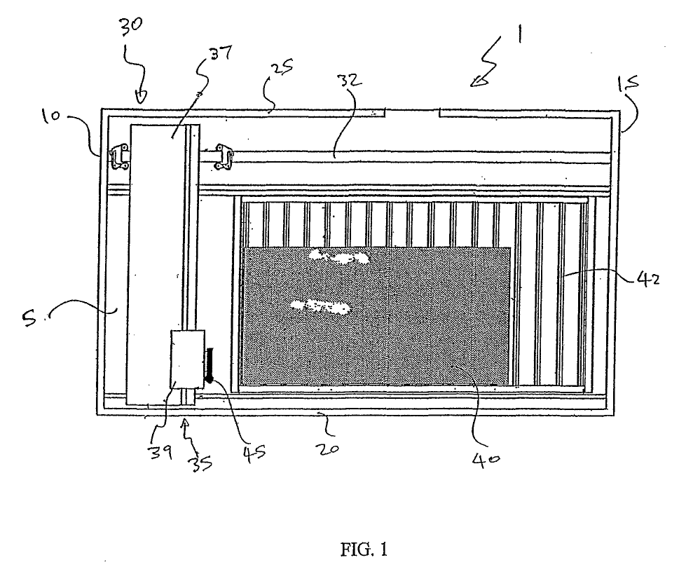

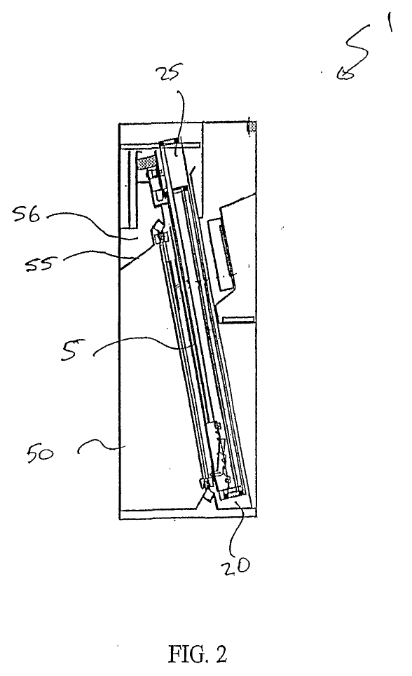

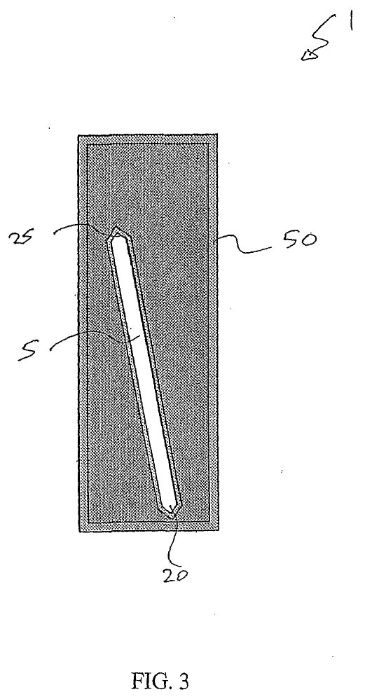

Referring to FIGS. 1 to 4, there is shown a cutting apparatus 1 including a base 5 for positioning on a generally horizontal surface such as a floor or the like. The base 5 includes upwardly extending first and second ends 10, 15 between which spaced sides 20, 25 extend to form a plane. The first side 20 preferably rests on a horizontal surface. As best seen in FIG. 2, the plane is substantially inclined by an acute angle from a vertical plane perpendicular to the horizontal surface. An acute angle should be considered 0 to 90 degrees. In a preferred form, the acute angle is less than 45 degrees. However, different angles can be utilised. A cutting device 35 to cut sheet material supported on the base 5 is mounted to the base 5 and is movable relative to the ends 10, 15 and sides 20, 25. Means urge the cuffing device 35 to desired locations relative to the sides 20, 25 and ends 10, 15 to thereby enable the device 35 to cut sheet material 40 at the desired locations. The urging means includes a carriage 30 mounted on the base 5 and movable relative to ends 10, 15 and sides 20, 25.

The carriage 30 includes a first assembly 37 to move the cutting device 35 between said ends 10, 15 and a second assembly 39 to move the cutting device 35 between the sides 20, 25. The assemblies 37, 39 can run along one or more guide rail(s) 32 or the like and be moved simultaneously or separately.

The urging means also includes a motor (not shown) operatively associated with the carriage 30 to change the location of the cutting device 35 with respect to the sides 20, 25 and ends 10, 15. One or more motors could be utilised. In a preferred form, the motors would be numerically controlled brushless motors. The cutting device 35 includes a cutting torch 45 including means to change the orientation of the torch 45 relative to the base 5 and assemblies 37, 39. The cutting torch 45 would be any suitable cutting torch which could include plasma, laser, water jet, oxy, printing head, knives for fabric cutting, hot wire, fret sawing, punching, milling or the like.

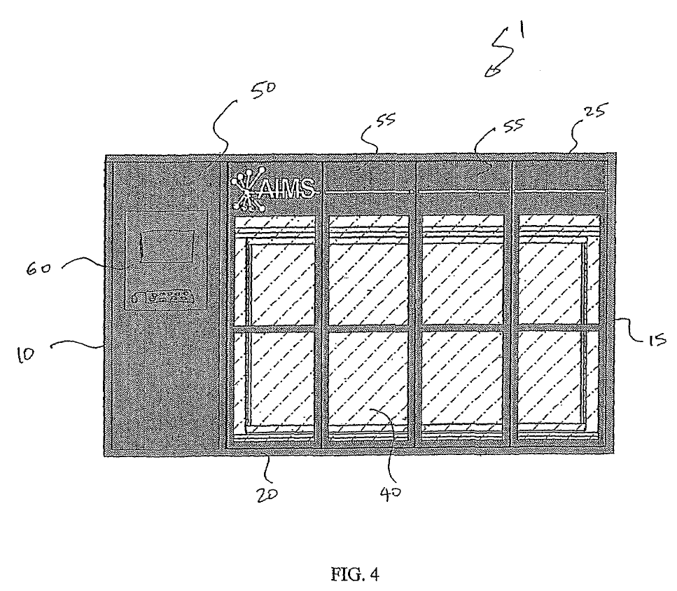

As best seen in FIG. 4, the apparatus 1 also includes a housing 50 having doors 55 to substantially surround the apparatus 1 to provide a secure operating environment when the apparatus 1 is in use. The apparatus 1 would preferably include electronic control means 60 such as computer numerical control or the like to assist an operator in cutting the sheet material 40. For example, the apparatus 1 could come with a personal computer running windows, a TFT screen, a keyboard and mouse, interpolation of X, Y and Z axis, hard disk storage or a wireless network card. The programming should be user friendly running for example G code, having automatic and manual control, diagnostics and error displays and graphical display, as well as actual and calculated run times. However, other computer and automation systems could be utilised. The apparatus 1 could also include a crane or the like (not shown) to assist an operator in moving heavy sheet material onto or about the base 5 and a dust extraction system (not shown) or a light (not shown).

The advantages of such a vertical cutting apparatus 1 at least in a preferred form are for example; that the apparatus 1 creates a small footprint due to the cutting plane being close or near vertical. In comparison other machines cover large areas of floor space due to the cutting plane being horizontal. When the vertical cutting apparatus 1 is placed against a wall a user can access all parts of the work area from the front of the apparatus 1. Horizontal cutting machines require space on all sides. The vertical cutting apparatus 1 creates easy access to the parts once cut as they are in front of a user and within arms reach. This reduces safety issues for the user and assists with easy cleaning of the apparatus 1. With existing cutting tables the user has to stretch over sharp sheets of material. Due to the easy access to the cut parts, the apparatus 1 is also more ergonomic for the user and assists with maintaining good posture. Occupational health and safety issues and workers compensation claims should be reduced with the apparatus 1 due to the design which in turn becomes a more efficient production machine. Cut parts can be held in place by “micro joints” or the like which could be incorporated into the apparatus 1. These joints allow the cut components to be held in the material, and a simple twist is all that is required to remove the cut components. Alternatively, the material with the cut components can be removed from the apparatus 1, and cut components separated when required. This is not possible on a horizontal type machine, as the sheet material bends (or bows) when it is picked up, and thus the little micro joints break.

The gas extraction system as seen in FIG. 2 allows the apparatus 1 to remove spent gases during the cutting process which are sucked from above through holes 55 into a sealed chamber 56 to which a common extraction system can be connected. As hot air rises, this makes it extremely efficient, whereas horizontal machines suck from the bottom which is not efficient. The X, Y & Z axis of the apparatus 1 can be constructed much lighter than existing machines as the inertia of the axis is directly beneath the rail 32. This way the axis movement is working with gravity and not against it, as with other types of machines. Further, the apparatus 1 allows the use of smaller motors on the axis movements in comparison to other machines, for the same given speed of axis movement.

Although the invention has been described with reference to specific examples, it will be appreciated by those skilled in the art that the invention may be embodied in many other forms.

1. A cutting apparatus including:
a base having upwardly extending first and second ends between which spaced elongate sides extend, with the ends and sides being located in a plane; said plane being inclined by an acute angle to a vertical plane of less than about 45 degrees;
a cutting device to cut sheet material supported on the base, the device being mounted on and moveable relative to the sides and ends; and
means to urge said cutting device to desired locations relative to said base thereby enabling said device to cut the sheet material at said desired locations;
wherein said cutting device includes at least one cutting torch.

2. The cutting apparatus according to claim 1, wherein said urging means includes a carriage to move said cutting device relative to said sides and ends, the carriage mounted on the base.

3. The cutting apparatus according to claim 1, wherein said carriage includes a first assembly to move said cutting device between said ends and a second assembly to move said cutting device between said sides.

4. The cutting apparatus according to claim 3, wherein said urging means includes a motor operatively associated with said carriage to change the location of said cutting device relative to said sides and ends.

5. The cutting apparatus according to claim 1, wherein said cutting device includes means to change the orientation of said at least one torch relative to said base.

6. The cutting apparatus according to claim 1, including a housing substantially surrounding said apparatus.

7. The cutting apparatus according to claim 1, wherein said apparatus includes electronic control means.

8. The cutting apparatus according to claim 1, wherein said apparatus includes a Computer Numerical Control System.

9. The cutting apparatus according to claim 1, wherein said apparatus includes a crane.

10. The cutting apparatus according to claim 1, wherein said acute angle is less than 15 degrees.
